(19) United States
(12) Patent Application Publication
(10) Pub. No.: US 2019/0212181 A1
(43) Pub. Date: Jul. 11, 2019

(54) Monitoring Hydration

(71) Applicants: Matej Marjanovic, Brezje (SI); Igor Marjanovic, Brezje (SI)

(72) Inventors: Matej Marjanovic, Brezje (SI); Igor Marjanovic, Brezje (SI)

(21) Appl. No.: 16/355,790

(22) Filed: Mar. 17, 2019

Related U.S. Application Data
(63) Continuation of application No. 14/257,432, filed on Apr. 21, 2014, now abandoned.
(60) Provisional application No. 61/813,934, filed on Apr. 19, 2013.

(51) Int. Cl. G01F 23/20; G01G 23/00; G01F 22/00; G01G 17/04; G01G 21/28

(52) U.S. Cl. CPC G01F 23/20; G01G 23/002; G01G 21/28; G01G 17/04; G01F 22/00

(57) ABSTRACT

A processing device receives a multitude of measurements from an orientation sensor. The orientation sensor is mounted to a container. A determination is made, from the multitude of measurements, that the container is in an angular position where a composite weight of the container and contents of the container bear down on at least one weight sensor. The at least one weight sensor is mounted to the container. At least three readings of the composite weight are taken from the at least one weight sensor. A validation is made that each of the at least readings of the composite weight are: (1) within a minimum value and a maximum value; and (2) are within a difference of less than a predetermined amount to each other. In response to the validating, a composite weight value based on the at least three readings of the composite weight is stored.

### CROSS-REFERENCE TO RELATED APPLICATIONS

This application is a continuation of U.S. patent application Ser. No. 14/257,432, filed Apr. 21, 2014, which claims the benefit of U.S. Provisional Application No. 61/813,934, filed Apr. 19, 2013, entitled “Automated Device for Collecting Mass Measurements of a Container,” which are hereby incorporated by reference in their entirety.

### BRIEF DESCRIPTION OF THE SEVERAL VIEWS OF THE DRAWINGS

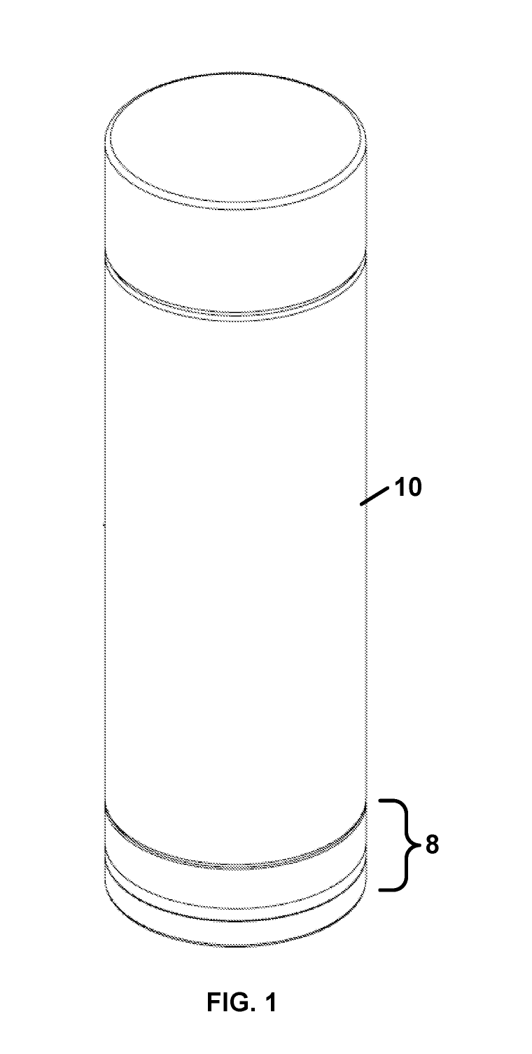

Example FIG. 1 is an elevated front view of a measuring device attached to the base of a water bottle as per an aspect of an embodiment of the present invention.

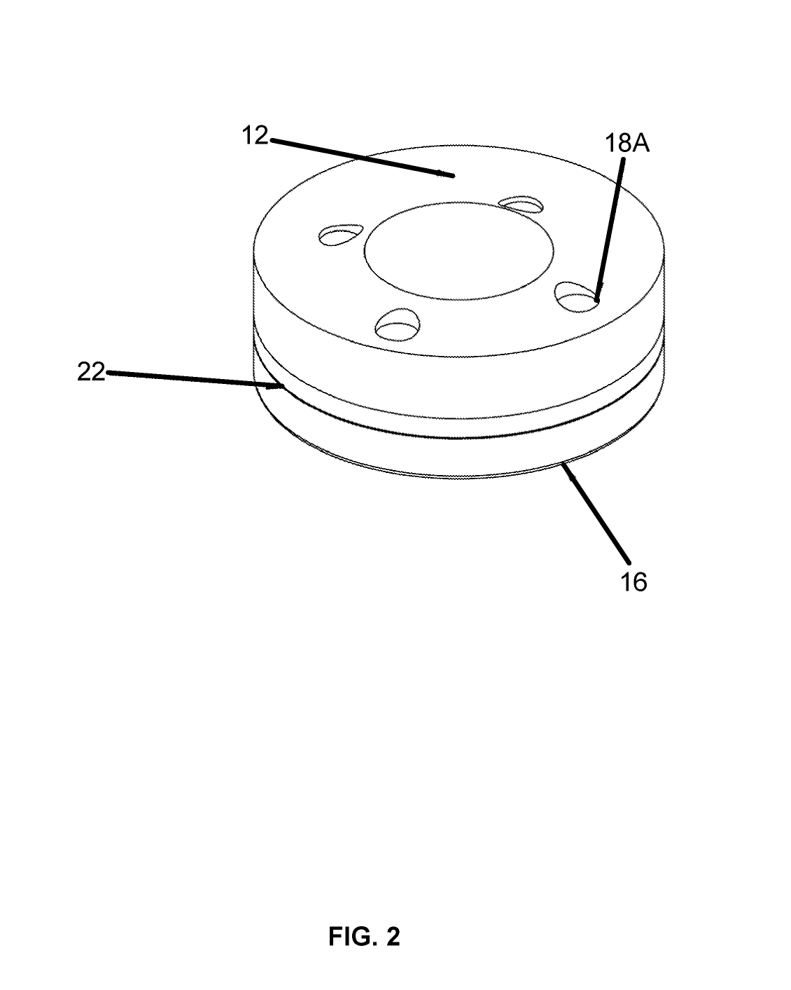

Example FIG. 2 is an elevated front view of a measuring device as per an aspect of an embodiment of the present invention.

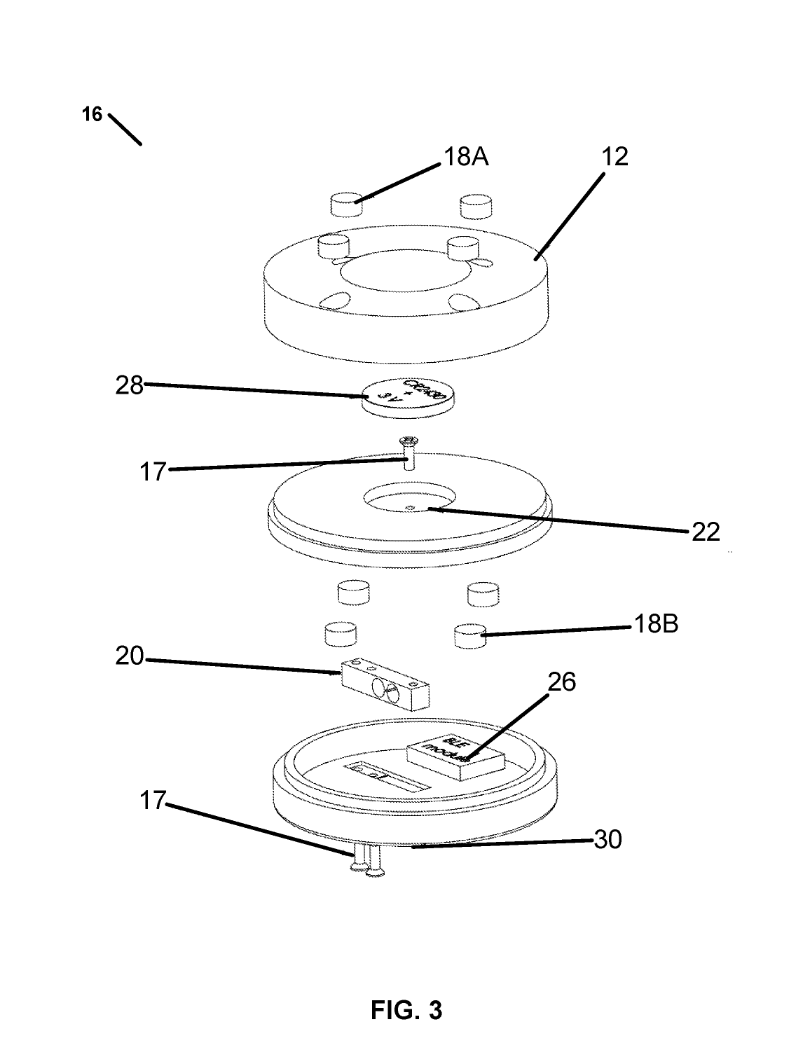

Example FIG. 3 is an exploded view displaying components of a measuring device as per an aspect of an embodiment of the present invention.

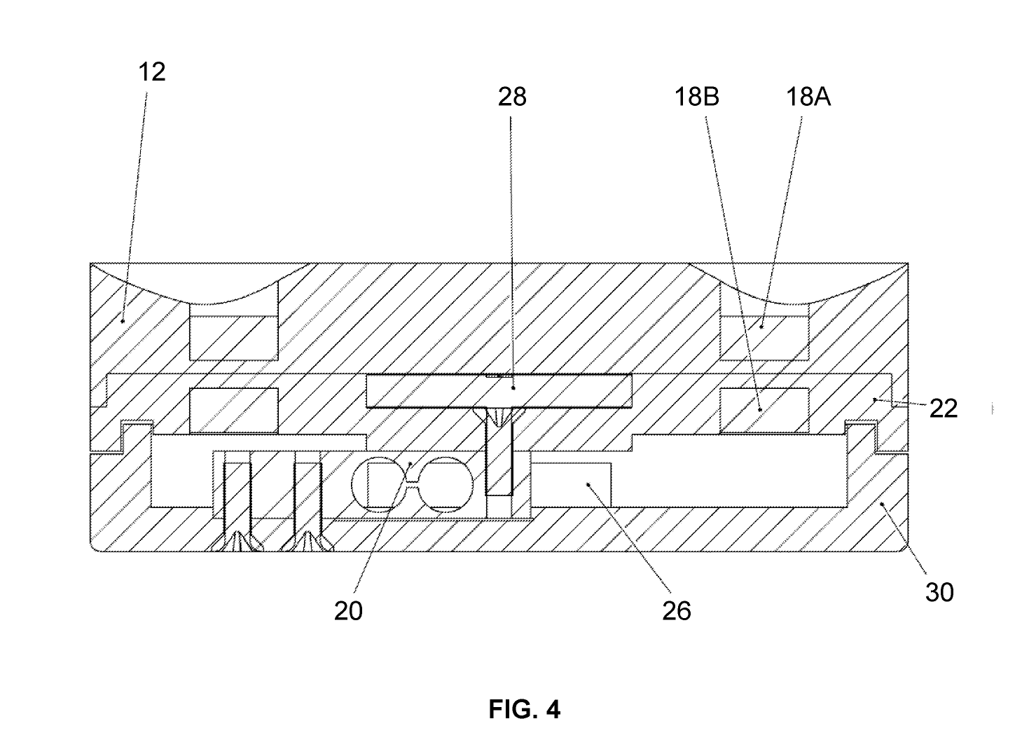

Example FIG. 4 is a sectional view of a measuring device as per an aspect of an embodiment of the present invention.

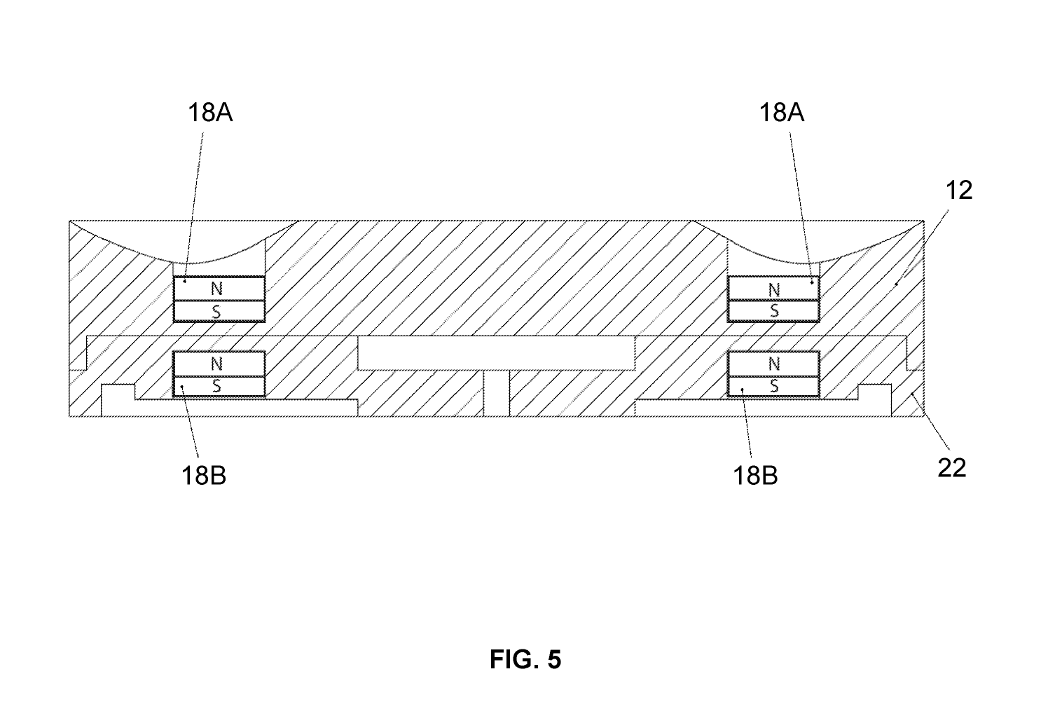

Example FIG. 5 shows magnets and their polarity as used in a measuring device, positioned so that the forces created by the magnets cause the upper and lower assembly to attach as per an aspect of an embodiment of the present invention.

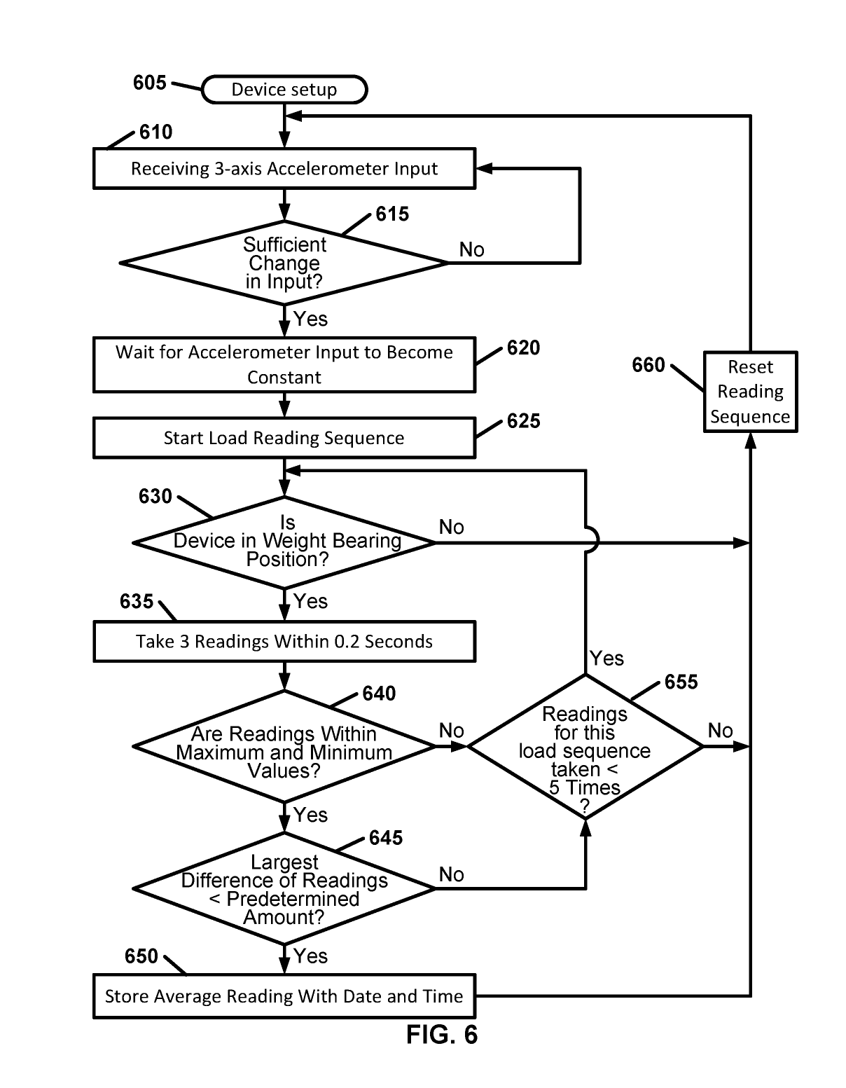

Example FIG. 6 is a flowchart illustrating a process for making measurements as per an aspect of an embodiment of the present invention.

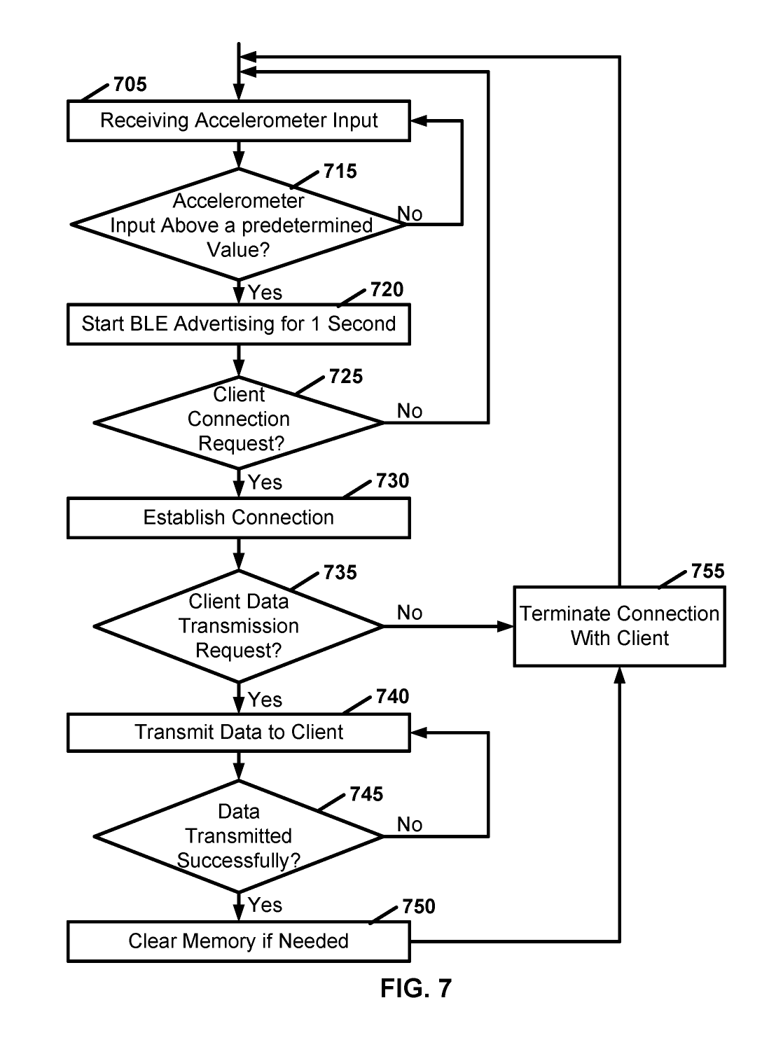

Example FIG. 7 is a flowchart illustrating a process for determining whether to transmit data as per an aspect of an embodiment of the present invention.

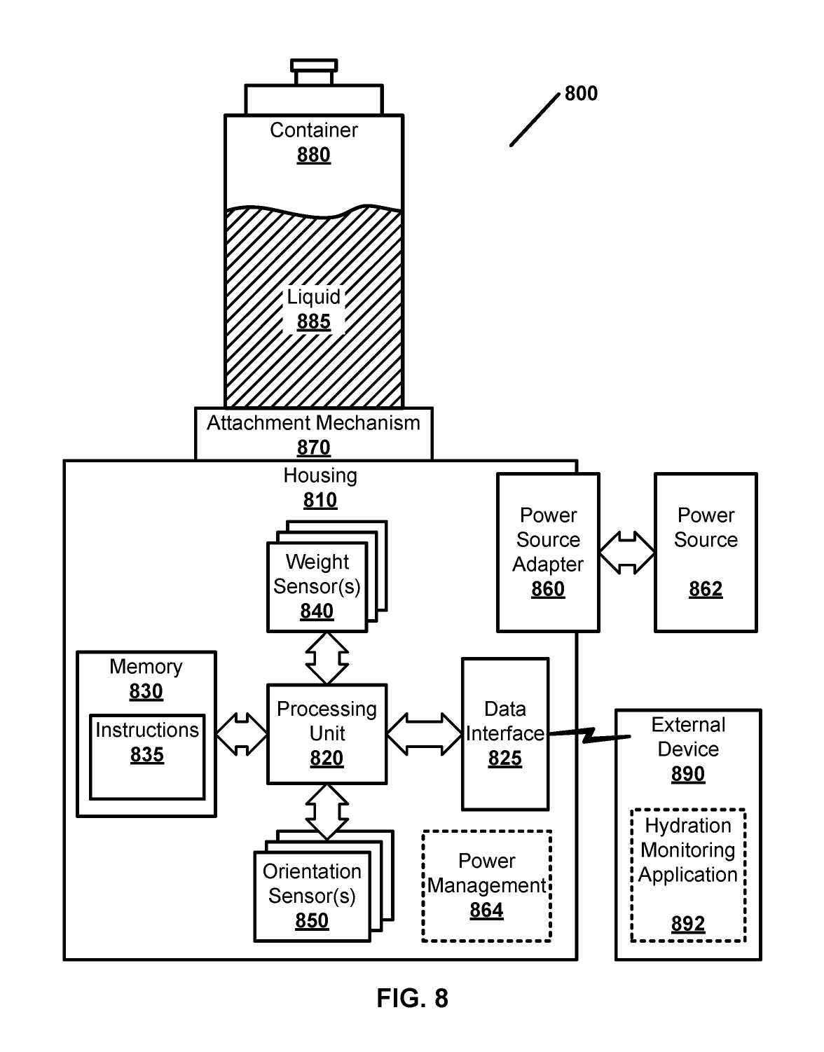

Example FIG. 8 is a block diagram of a hydration monitor as per an aspect of an embodiment of the present invention.

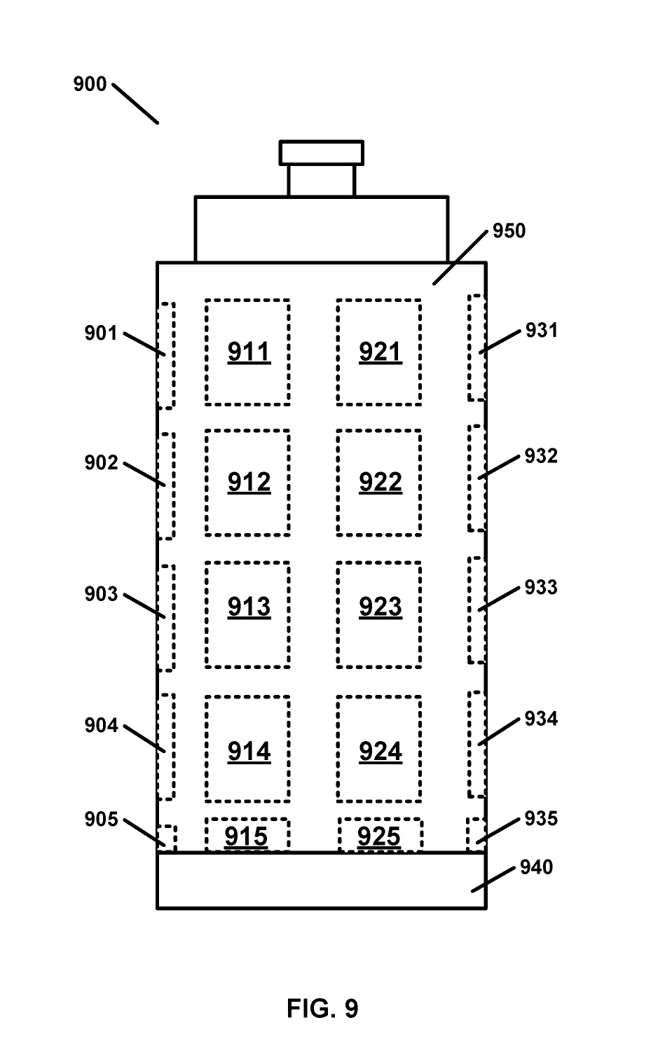

Example FIG. 9 is a diagram of a container as per an aspect of an embodiment of the present invention.

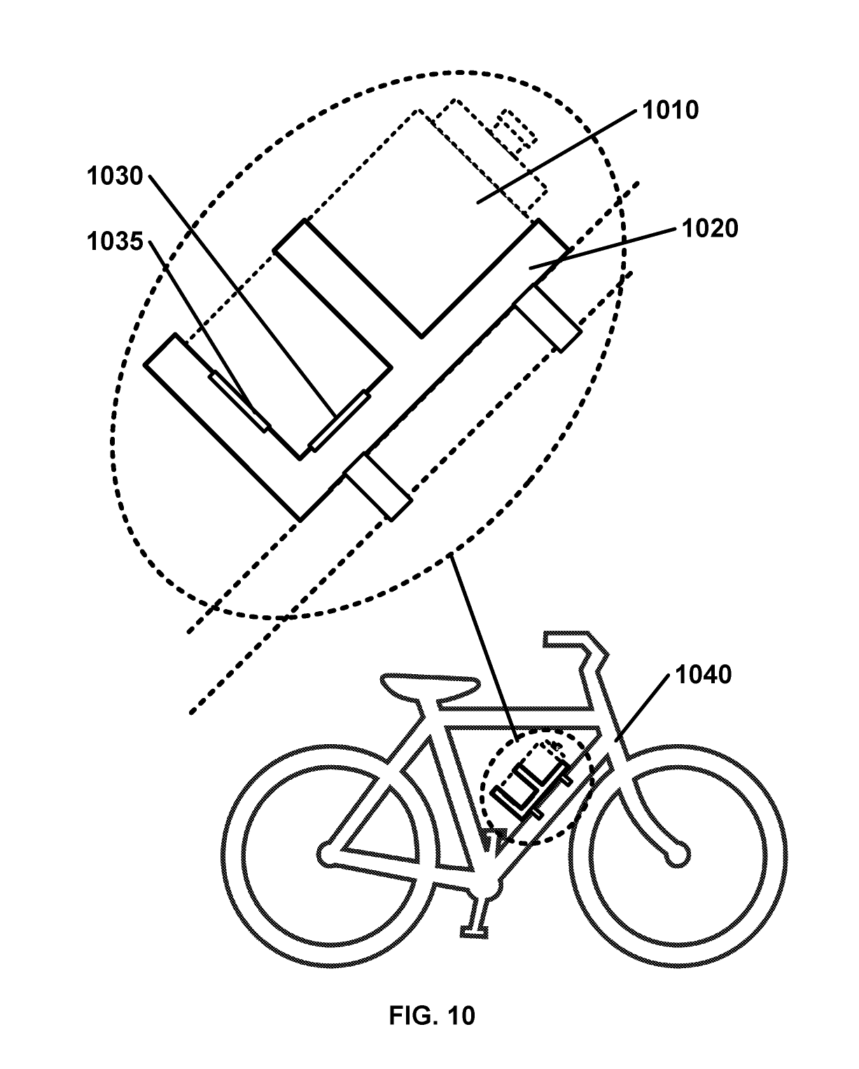

Example FIG. 10 is a diagram of a container and housing mounted on bicycle as per an aspect of an embodiment of the present invention.

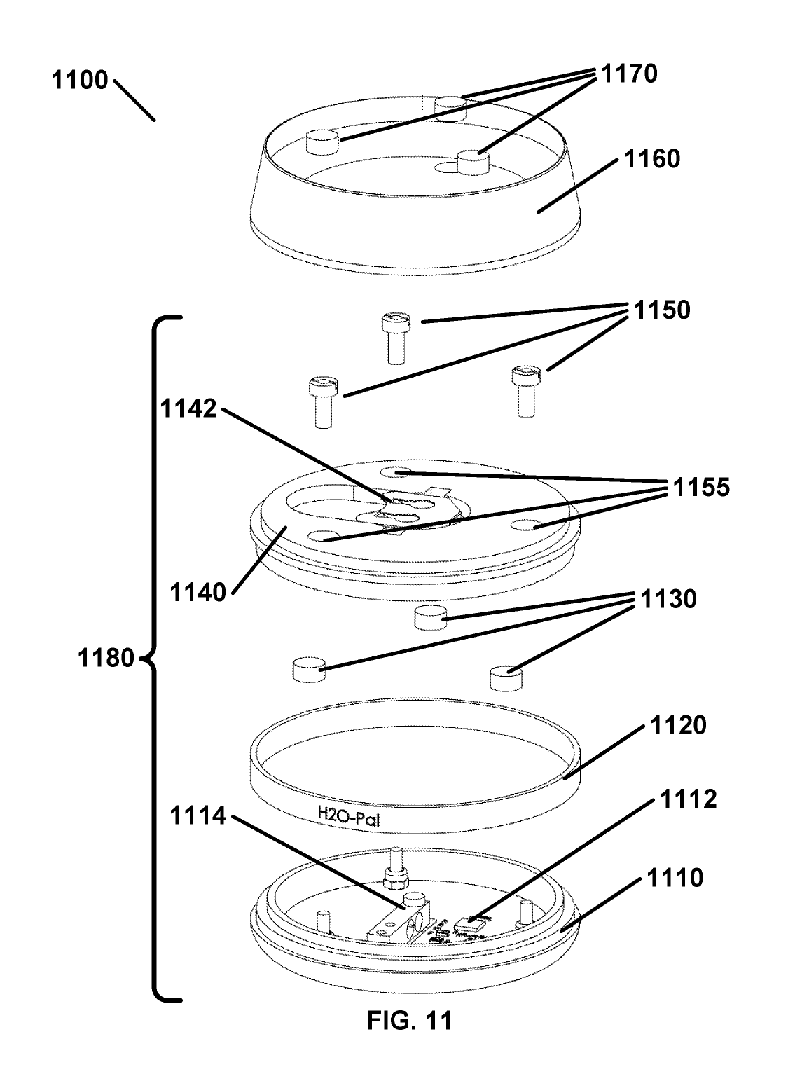

Example FIG. 11 is an exploded view displaying components of a measuring device as per an aspect of an embodiment of the present invention.

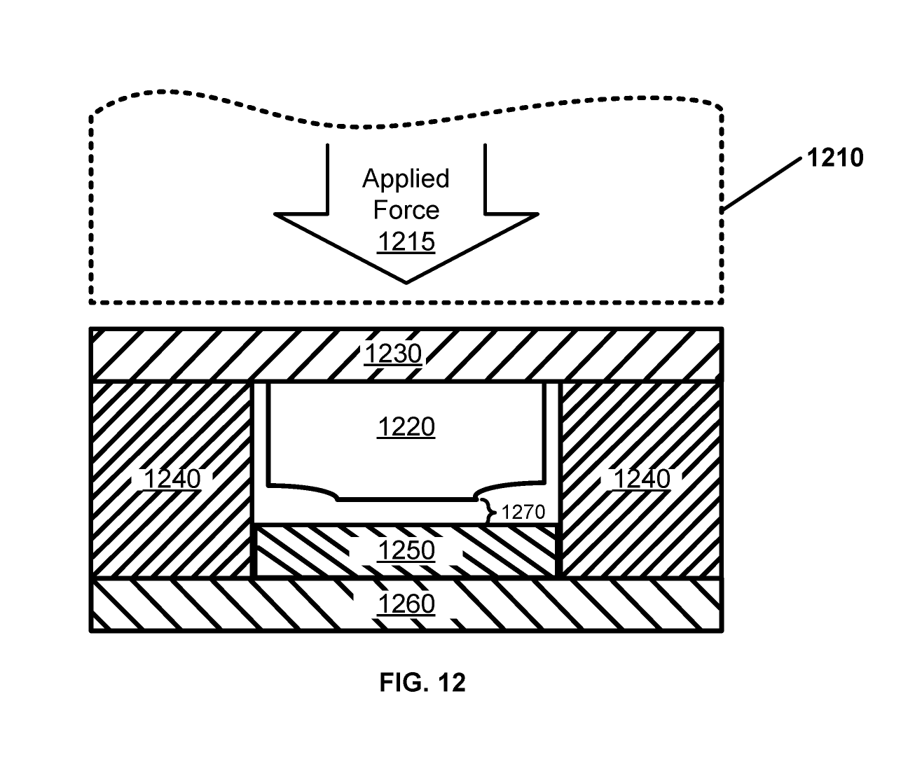

Example FIG. 12 is a block diagram of a weight sensor as per an aspect of an embodiment of the present invention.

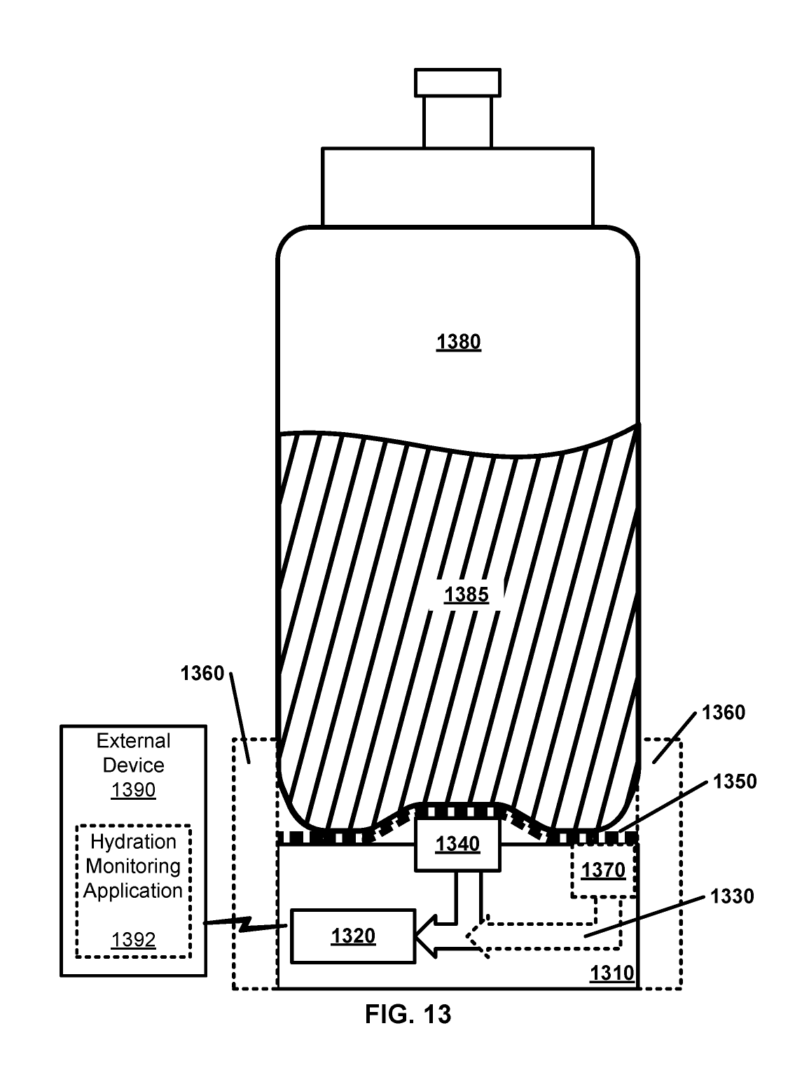

Example FIG. 13 is an illustration of an alternative configuration of a hydration monitor as per an aspect of an embodiment of the present invention.

### DETAILED DESCRIPTION OF EMBODIMENTS

Some of the various embodiments of the present invention automatically track consumption of liquid from a bottle through periodic mass measurements of the bottle.

According to some of the various embodiments, a measurement device may be attached to the base of a container so that when the container is in its upright position (container bearing position) the measuring device may ensure that the base of the container is not touching the ground and the measuring device experiences the weight of the container and its contents. The measurement device (e.g. mass measurement device) may, for example, use a module containing a microchip that monitors, for example, signals from a weight sensor (e.g. load cell) and an orientation sensor (e.g. 3-axis accelerometer). The accelerometer may be calibrated so that the microchip is able to detect readings when the container is in an upright position. After the accelerometer or load cell readings have been disturbed by a specified amount, the microchip may monitor accelerometer readings to determine when the container is in an upright position. When the microchip detects the container is in an upright position, the microchip may initiate a sequence to obtain a valid mass measurement. In this example sequence, the microchip determines whether the reading is within a minimum and maximum range of readings and makes repeated measurements in a short time frame. When the measurements are within a predetermined range of each other, an average measurement may be recorded by the microchip. The measurement may also be recorded together with the date and time of the measurement.

The measuring device, according to some of the various embodiments, may also communicate collected data to an external device. The communication may be performed wirelessly using, for example, a Bluetooth Smart or similar technology. During transmission of the measurements, other data such as the energy status of the battery may be communicated. Transmitted data may be stored and/or analyzed on the external device. Examples of external devices include, but are not limited to, smartphones, tablets, computers, servers, combination thereof, and/or the like. The external device(s) may employ applications to provide feedback regarding the use of the container, and in some embodiments, the amount of liquid remaining in the container. The data may be linked to a user profile. A user, according to some embodiments, may link several measuring devices to his or her profile. The user's profile and data collected from the measuring device(s) may also be stored in an online database. Once the data is safely communicated to an external device, the measuring device may erase some or all of the previous measurements to allow further data collection. The quantity of previous measurements erased may be dependent on the amount of available storage after the data is communicated. Additionally, the measurements and/or other data may be compressed.

The data may be employed to monitor the consumption and addition of material (e.g. liquid, food) in a container. Data that represents mass measurements may be converted to volume data. Volume data may be applicable to the contents of the container. The conversion of mass data to volume data may employ correlations between the mass of the content and the volume of the container. For example, the weight of a full container and an empty container may be employed to determine a correlation of weight and mass. In yet another example, if the container contains liquid with a known density, such as water, then the mass measurements may employ the density value to convert the mass data into volume data.

Some of the various embodiments may automate mass readings employing devices such as accelerometer(s) and load cell(s). A measuring device may be an attachable part or a permanent part of a container. The measuring device may be configured to not limit the usability of the container. The container may be a water bottle, a baby bottle, a hydration backpack, and/or the like. For example, the measuring device may be attached to the container using heat shrinking rubber material or double sided adhesive tape.

The measuring device may store readings with the time and date of when each measurement was made. This time and date data may be referred to as a timestamp. Timestamps may be associated with individual measurements or collections of measurements.

The measuring device may acquire measurement data over various time periods. The data may be communicated to an external device such as a computer, smartphone, tablet or other device to analyze or manipulate the data. The measuring device may perform actions to determine invalid measurements (e.g. mass too high, too low or too much variance).

Some embodiments may employ a load cell to take mass measurements. The compression of a load cell may be, according to some embodiments, the only moving part of the measurement device when the device is operating. This may reduce the possibility of a malfunction in comparison with other devices that measure the volume of liquid subtracted from a container using a device such as a mechanical flow meter.

Some measurement devices may be constructed in a small form factor due to the size of various components. (e.g. controller, battery, load cell, etc.). The measurement device may be sold and packaged separately from the containers with which it is used. This may enable a single measurement device to be rotated between various water bottles. So for example, a single measurement device could be shared between multiple users who each use a separate water bottle, or between multiple water bottles used by a single user.

Some embodiments of the measurement device may be configured to operate autonomously for periods of time. For example, a device could employ a Bluetooth Smart technology, which enables the use of very little energy for the collection of measurements and their transmission to obtain an operational life of several days to months between charges or battery replacement. Bluetooth Smart may enable the measuring device to only transmit data only to those devices which have been granted access to the measuring device by the operator of the measuring device.

Some of the embodiments of the measurement device may be configured to employ magnets to connect a lower part of the measurement device containing a load cell and/or other electrical components to an upper part that is attached to the base of the container. This example configuration may allow the lower part of the device to disconnect with the upper part if it experiences a large force which could damage the enclosure as well as the components within the enclosure. This example configuration may also allow for easy access to replace a battery.

An example embodiment of a measurement device 8 is shown with a container 10 in FIG. 1. The measuring device 8 may comprise an upper assembly 12 with corresponding magnets 18A and a lower assembly 16 as seen in FIG. 2. An example employed method of attaching upper assembly 12 to container 8 may be double sided adhesive tape disposed in-between the bottom of the container 8 and the top of the upper assembly 12. The container and the upper assembly may be pressed together so both container 8 and upper assembly 12 make firm contact with the double sided adhesive tape.

The lower assembly 16 may comprise several components as shown in FIG. 3. Magnets 18B may be located in the bottom of load bearing plate 22 so that they correspond to magnets 18A on the upper assembly 12. A load cell 20 may be connected to a load bearing plate 22. Illustrated module 26 may, for example, comprise a 3-axis accelerometer, a microchip and transmission capabilities via an antenna. Module 26 may be connected to load cell 20. Battery 28, which may be located at the top of lower assembly 16, may provide power to the microchip and the measuring instruments. A base 30 for the lower assembly may be employed to allow module 26 to be attached to load cell 20. Bolts 17 may be employed to connect load cell 20 to the bearing plate 22 and to connect load cell 20 to base 30.

Example base 30 may be configured so that there is a small displacement between load-bearing plate 22 and base 30. Example base 30 may also be configured with a corresponding gap below load cell 20 and base 30 as show in FIG. 4. The displacement may remain so long as the weight pressing down on load bearing plate 22 does not exceed the capabilities of load cell 20. Load cell 20 may be attached so that it is firmly fixed to the base 30.

Module 26 may comprise processing and communications capabilities. For example, module 26 may comprise microcontroller(s) and Bluetooth Smart transmission device(s). Module 26 may also contain an embedded program arranged to perform, among other functions, mass collection and data communication functions. For example, module 26 may gather mass measurements using, for example, the process described in example FIG. 6 and to determine when to start transmission of gathered measurements, as described in example FIG. 7. The transmission of data may be performed using a protocol consistent with the hardware communications capabilities. For example, if communications is performed using Bluetooth, a Bluetooth Smart transmission protocol may be employed.

According to some of the various embodiments, a processing module may monitor readings from a load cell and a 3-axis accelerometer and collect measurements using actions such as those described in example FIG. 6. Measurement data together with the date and time of the measurements may be collected using these actions. The measurement device may enable wireless transmission of gathered measurement data as described in example FIG. 7. Data may be transmitted using a standard Bluetooth Smart transmission protocol. In this example embodiment, security features possible by the Bluetooth Smart mode of transmission may be used so that data is encrypted during transmission and that data is transmitted only to devices for which the owner of the measuring device permits.

A process for making intelligent mass measurements of a container is illustrated in the flowchart in example FIG. 6. When the device is powered it may execute instructions to perform a setup process at 605. The device may enter a state to receive input from an accelerometer at 610. Input from the accelerometer may be employed to make a determination at 615 whether sufficient change in input occurred. A threshold considered for the bottle 10 with attached measuring device 8 seen in FIG. 1 may be set to approximate the accelerometer disturbance when a person picks up the bottle 10. If the determination at 615 is negative, the process returns to the state at 610. If the determination at 615 is positive, the process may continue at 620 to determine when the input from the accelerometer becomes stable.

Once the reading has become stable, the process may enter a load reading sequence at 625. The process may continue at 630 where a determination is made if the measurement device 8 is in a measurable position. The measurable position may be defined as a position where, given the current input from the accelerometer, a determination of the weight of the container 10 and its contents (composite weight) may be made. One example of such a measurable position is when the input from the accelerometer indicates that the measurement device 8 and container 10 is oriented so that they are approximately perpendicular to the horizontal plane and are experiencing normal gravitational acceleration. If the determination at 630 is negative, the process may continue at 660 where the reading sequence is reset. If the determination at 630 is positive, the process may continue at 635 where one or several readings are obtained by a weight sensor. At 635, three readings, for example, may be taken within 0.2 seconds. The process may continue at 640, where a determination may be made if the measurements are within a specific range of values. The range may be determined by anticipating the forces the weight sensor would experience in normal operation. If the determination is negative, the process may continue at 655. At 655 a determination may be made based on how many attempts to obtain a reading have been made for the current load bearing sequence. If the number of attempts is greater than a specific number, for example five, then the process may continue at 660. Otherwise, the process may return to state at 630. If the determination at 640 is positive, the process may continue at 645, where the largest value difference in the readings obtained at 635 is computed. A determination may be made if the computed value difference is less than a predetermined amount. This may indicate that the measurement was reliable. If the determination is negative, the process may continue at 655. If the reading is positive, the process may continue at 650. At 650, the average reading based on the measurements may be calculated and the average reading stored in memory with a timestamp of when the measurement was taken. The process may continue at 660, where the reading sequence may be reset. After the reset at 660, the process may return to monitoring accelerator input at 610.

An example process for transmitting data to an external device that supports a mode of transmission of a device (such as a smartphone, tablet or personal computer) is shown in the flowchart in example FIG. 7. At 705, the input from an accelerometer may be monitored. At 715, a determination may be made if there is a sufficient identifiable change in accelerometer output values. The measurement device may be configured to detect accelerator input resulting from specific actions made by the user. For example, the accelerometer could determine if the user manually shakes the device up and down, or left and right, or places the device in a particular orientation, as well as introduce any kind of rotation. One such example would be to place the device in a specified position (e.g. an upside down vertical position, which could be detected by the accelerometer. When the accelerometer detects such movement or orientation, the process at 715 may make a positive determination. If the determination at 715 is negative, the process may return to 705. If the determination at 715 is positive, the process may continue at 720 where the device begins to advertise a Bluetooth connection (e.g. to pair the measurement device to the external device). The advertising time may be approximately one second. The process may continue at 725, where a determination of whether a valid client connection request for a Bluetooth Smart communication was received. If the determination at 725 is negative, the process may return to 705. If the determination at 725 is positive, the process may continue at 730 where a connection is established with a device that made a connection request. Once the measurement device is paired to an external device, it may periodically reconnect with the external device when the external device is within communication range.

The process may continue at 735 where a determination may be made if the connected device has requested data. If the determination at 735 is negative, the process may continue at 755 and the connection terminated. If the determination at 735 is positive, the process may continue at 740 where the data is transferred to the client. The process may continue at 745 where a determination may be made if the data transfer was completed successfully. If the determination at 745 is negative, the process may return to state at 740. If the determination at 745 is positive, the process may continue to 750. At 750, memory allocated to data transmitted at 740 may be cleared. The process may proceed to step 755 where the device terminates the connection with the client. The process may return to state 705 if the connection with the client is lost after it has been established at 730.

Example FIG. 8 illustrates a hydration monitor 800 according to an aspect of an embodiment of the invention to track and report liquid intake for purposes such as, but not limited to, encouraging proper hydration.

The hydration monitor 800 may comprise a housing 810 and an attachment mechanism 870. The attachment mechanism 870 connects the housing 810 to a container 880. The housing contains circuitry that may be employed to measure liquid 885 in the container 880. In some of the various embodiments, the container 880 is a bottle configured to dispense liquid 885 to a user. The measurements may be employed to determine hydration information for the user.

The housing 810 comprises a processing unit 820, a power source adapter 860, weight sensor(s) 840, orientation sensor(s) 850, data interface(s) 825, and a memory 830. The housing 810 may be water resistant and/or water proof to protect components residing in the housing from liquid damage. To that end, the housing may employ many materials such as plastics, composites, metals, alloys, sealed natural materials (e.g. sealed wood), rubber, synthetic materials, gaskets, combinations thereof, and/or the like.

Various configurations of the housing 810 may be employed to enable the housing 810 to interact with the container 880. For example, in some embodiments, the housing 810 may be configured to be a base portion of container 880. In other embodiments, the housing 810 may be configured as a holder for the container 880. Examples of a holder may include, but are not limited to a car cup holder, a bicycle water bottle holder, desktop trivet, a soda can sleeve, a stand, a pouch, combinations thereof, and/or the like.

The container 880 may be a handheld container. Examples of handheld containers include, but are not limited to: water bottles, sport bottles, soda cans, and/or the like. Container 880 may be configured to hold water or other beverages (885) for consumption or other uses. Container 880 may allow an individual to transport and carry a beverage from one place to another.

Container 880 may be made of materials such as plastic, glass, metal, ceramics, glass, carbon composites, a combination of the above and/or the like. Plastics may include materials such as high-density polyethylene (HDPE), low-density polyethylene (LDPE), copolyester, polypropylene, and/or the like. Specific plastics may be selected based on a desired flexibility of the container 880. Copolyester and polypropylene bottles may offer the greatest rigidity. HDPE bottles may retain some pliability, while LDPE bottles (most commonly associated with ‘squeeze’ type bottles) may be employed for highly flexible and collapsible containers.

Metal containers 880 may be constructed from materials such as stainless steel, aluminum and alloys. Metal containers 880 may be employed for durability and to retain minimal odor or taste from contents. Some metal containers may include a liner of a material such as a plastic resin or epoxy to protect contents from taste and odor transfer. Glass containers may also be employed as a container 880. Glass containers may be recyclable, BPA free, and transfer minimal taste or odor. Glass containers may be heavier than plastic, stainless steel or aluminum bottles.

Container 880 may be configured in various shapes, colors and sizes. According to various embodiments, container 880 may be either disposable and/or reusable. Reusable containers 880 may also be used for liquids such as water, juice, tea, iced tea, coffee, alcoholic beverages, soft drinks, soap, oil, milk, sports drinks, protein shakes, combinations thereof, and/or the like. Some containers may be configured as a backpack, a compressible container, a cup, a mug, a bottle, a baby bottle, a bladder, combinations thereof, and/or the like. Container 880 may be configured so that the weight of container contents (e.g. liquid 885) may be determined using weight sensors 840.

The processing unit 820 may be communicatively coupled to memory device 830. Examples of processing units may include circuits that include electronic processing devices such as microcontrollers, computers, processing boards, application-specific instruction-set processors, signal processors, application-specific integrated circuits (ASIC), signal processors, field-programmable gate arrays (FPGAs), and/or the like. A microcontroller (sometimes abbreviated μC, uC or MCU) is a small computer on a single integrated circuit containing a processor core, memory, and programmable input/output peripherals. Program memory 830, random access memory (RAM), data interface 825, interfaces to weight sensor(s) 840, interfaces to orientation sensor(s) 850, power management functions 864, among other devices, may be included on chip. Microcontroller chips may be obtained from companies such as Texas Instruments of Dallas, Texas, Nordic Semiconductors of Oslo, Norway, Silicon Labs of Austin, Tex., Freescale Semiconductor, Inc. of Austin, Tex., and Intel of Santa Clara, Calif. Some processing units may employ optical computing. Optical or photonic computing may employ photons produced by lasers or diodes for computation. It is envisioned that other types of processing logic may be employed to the extent that the processing logic enables the functionality described herein, namely processing weights and orientations to determine and communicate hydration values to a user.

Memory device 830 may be collocated with processing unit 820. In some embodiments, the memory device 830 may be located in the same integrated circuit device as processing unit 820. In other embodiments, memory 830 may be located external to processing device 820. Memory 830 may include physical devices used to store programs (sequences of instructions) or data (e.g. program state information) on a temporary or permanent basis for use with processing unit 820. Memory 830 may include addressable semiconductor memory, i.e. integrated circuits consisting of silicon-based transistors. Memory 830 may include volatile memory devices and/or non-volatile memory devices. Examples of non-volatile memory are flash memory and ROM/PROM/EPROM/EEPROM memory. Examples of volatile memory are primary memory (typically dynamic RAM, DRAM), and fast CPU cache memory (typically static RAM, SRAM).

Power source adapter 860 may be configured to connect a power source to provide power to processing unit 820. In some of the embodiments, the power source adapter 860 may be configured to connect power to other devices such as data interface 825, weight sensor(s) 840, and orientation sensors(s) 850. The power source adapter may be configured to work with specific types of power source(s) 862. One type of power source 862 may be a battery. In the case that the power source is a battery, the power source adapter 860 may be a mechanical battery containment and associated terminal connections for the battery. Batteries may include primary batteries or secondary batteries. Primary batteries include single-use or “disposable” batteries that may be used once and discarded. Common examples of primary batteries include zinc-carbon batteries and alkaline batteries. Secondary batteries are rechargeable batteries that may be discharged and recharged multiple times. Examples of secondary batteries include lead-acid batteries, lithium ion batteries, gel batteries, absorbed glass matt batteries, nickel-cadium batteries (NiCd), nickel-zinc batteries (NiZn), nickel metal hydride batteries (NiMH), and/or the like. The housing 810 and/or power source adapter 860 may be adapted to employ batteries of many shapes and sizes, from miniature cells to standard cells (e.g. AAA sized cells, AA sized cells, C sized cells, D sized cells, etc.). Other types of batteries such as gel cells may also be employed.

According to some of the various embodiments, the power source may comprise an external power supply such as an AC adapter, an AC/DC adapter, and/or an AC/DC converter. In these embodiments, the power source adapter 860 may comprise an electrical plug (female) or receptacle (male) compatible with the AC adapter. Examples of employable receptacle and plugs are defined in EIAJ (Electronic Industries Association of Japan) standard RC-5320A, DIN (German Institute for Standardization) standard 45323 and IEC (International Electrotechnical Commission) standard 60130-10. Other names for external power adapters include plug pack, plug-in adapter, adapter block, domestic mains adapter, line power adapter, wall wart, and power adapter. According to some of the various embodiments, the external power adapter may be employed to recharge batteries.

According to some of the various embodiments, the power source may comprise a wireless power source. Wireless power or wireless energy transmission is the transmission of electrical energy from a power source to an electrical load without man-made conductors. Wireless transmission is useful in cases where interconnecting wires are inconvenient, hazardous, or impossible. Wireless power transmission may, for example, be carried out using direct induction followed by resonant magnetic induction. In this type of embodiment, the power source adapter 860 may include an inductive coil that can receive power when placed near an inductive power source. Devices such as the Texas Instruments bq51013A and bq51013B devices for wireless power transfer may be employed.

Yet additional embodiments may employ solar powered power source(s). In these embodiments, solar cells, for example, may be integrated into the housing or mounted external to the housing and provided to the hydration monitor via the power source adapter 860. In these embodiments, the power source adapter 860 may employ a plug or receptacle to receive the solar produced power. According to some of the various embodiments, the power source adapter 860 may further include power regulating devices such as voltage regulators and/or current limiting devices to adjust incoming power to the requirements of the hydration monitor circuitry.

The weight sensor(s) 840 may be connected to the processing unit 820 and configured to measure a composite weight. The composite weight comprising a container 880 weight and a liquid 885 weight. The liquid 885 weight may represent the weight of a liquid 885 contained by the container 880. The container 880 may be configured to dispense the liquid, resulting in a variation of the liquid weight and composite weight.

Weight sensor(s) 840 may include a transducer employable to convert a force into an electrical signal. According to some of the various embodiments, this conversion may be indirect and happen in two stages. Through a mechanical arrangement, the force being sensed may deform a strain gauge. The strain gauge measures the deformation (strain) as an electrical signal, because the strain changes the effective electrical resistance of the wire. One embodiment of a weight sensor 840 is often termed a load cell and may consist of four strain gauges in a Wheatstone bridge configuration. Load cells of one strain gauge (quarter-bridge) or two strain gauges (half bridge) may also be available. The electrical signal output is typically in the order of a few millivolts and may require amplification by an instrumentation amplifier. The output of the transducer may be scaled to calculate the force applied to the transducer. Example types of the various load cells include Hydraulic load cells, Pneumatic load cells and Strain gauge load cells, and/or the like. Other types of weight sensor(s) 840 may include piezoelectric load cells, vibrating wire load cells, and capacitive load cells where the capacitance of a capacitor changes as the load presses the two plates of a capacitor closer together, pressure sensors, scale sensors, spring sensors, and/or the like. Example pressure sensors include: the FS-2513P Piezo film based sensor from Prowave Electric Corp. of Taiwan, the FSS1500NSB sensor from Honeywell International Inc. of Moorestown, N.J., the FS20 from Measurement Specialist of Hampton, Va., the S215 from Strain Measurement Devices of Wallingford, Conn., and/or the like.

The weight sensor(s) 840 may be disposed inside the container. In these embodiments, the sensors may be electrically connected to the components in the housing. According to some embodiments, the housing 810 and the container 880 may be integrated. Therefore, it is anticipated that some embodiments may be employed that do not have a discrete attachment mechanism 870, but rather attachment mechanism 870 may be a common material to both the housing 810 and container 880.

According to some of the various embodiments, at least two of the weight sensor(s) 840 may be configured as a grid. This grid may allow a determination to be made as to the liquid 885 contained in the container 880, even when the container 880 is at an angular position. In other words, the differential and/or absolute weight distribution of the liquid 885 on the various weight sensor(s) 840 may be employed to determine the total weight of the liquid 885. FIG. 9 shows an example water bottle with a grid of sensors 900. In tis example embodiment, the grid of weight sensors (901, 911, 921, 931, 902, 912, 922, 932, 903, 913, 923, 933, 904, 914, 924, and 934) may be placed along the side of the water bottle 950. These sensors may provide weight information for the liquid contained in the water bottle when the water bottle is at an angle. The grid of weight sensors (905, 915, 925, and 935) may be located at the base of the water bottle 950. These sensors may provide weight information for the liquid contained in the water bottle pressing down. The differential and/or absolute weight measurements may be employed to determine the angle of the water bottle 950 and/or the amount of liquid contained in water bottle 950. This illustrated example water bottle embodiments shows a housing base 940 to process and communicate measurements from the grid of weight sensors (901, 911, 921, 931, 902, 912, 922, 932, 903, 913, 923, 933, 904, 914, 924, 934, 905, 915, 925, and 935).

The grid of weight sensors 840 may be positioned inside or outside the container 880. The grid of weight sensors 840 may be placed outside the container in applications such as a bottle carrier. Example bottle carriers include, but are not limited to: baby bottle carriers, running belts, backpacks, desktop bottle carriers, bicycle carriers, and/or the like.

FIG. 10 is an example illustration of an embodiment where the housing 1020 is a bottle carrier mounted to a bicycle 1040 configured to hold container 1010. In this example embodiment, weight sensors 1035 and 1030 are mounted perpendicular surfaces of the bottle carrier 1020. The differential and/or absolute pressures on weight sensors 1035 and 1030 may be employed to determine the weight of the liquid in container 1010. It should be pointed out that in this embodiment, the weight sensors 1030 and 1035 may also be employed as orientation sensors since the orientation of the bottle may be determined using the differential and/or absolute pressures on weight sensors 1035 and 1030. Additionally, sensors may also be employed to note when the bottle is fully seated in the bottle carrier 1020 to determine when container 1010 is in a measurable position. This grid of two sensors 1030 and 1035 on the bottle carrier 1020 may be expanded according various embodiments to employ additional weight sensors.

According to some of the various embodiments, orientation sensor(s) 850 may be connected to processing unit 820 and configured to measure at least one orientation value of the container 880 relative to the weight sensor(s) 840. The orientation sensor(s) 850 may be employed to determine when the container 880 is in a suitable position for the weight sensor(s) 840 to register accurate measurements. As discussed above, in some embodiments, weight sensor(s) 840 may be employed to help determine if the container 880 is properly oriented to take accurate weight measurements. However, other embodiments may use additional and/or other orientation sensors to make this determination. Some embodiments may use accelerometer(s) as orientation sensor(s) 850 to determine the orientation of the container 880. The accelerometer(s) may be 2D and/or 3D accelerometer(s). Example accelerometer(s) that may be employed in constructing various embodiments include: the LIS3x from STMicroelectronics of Huntsville, Ala., the ADXL3x from Analog Devices of Norwood, Mass., the BMAx from Bosch Sensortec of Kusterdingen, Germany, the MMAx from Freescale Semiconductor of Austin, Tex., the SCC1300-D02-05 from Murata Electronics, the KXx from Kionix of Ithaca, N.Y., and/or the like.

Some of the various embodiments may employ a gyroscope as an orientation sensor. Example accelerometer(s) that may be employed in constructing various embodiments include: the FXAS21000 from Freescale Semiconductor, the SCC1x from Murata Electronics, the KGY from Kionix, the L3Gx from STMicroelectronics, and/or the like. Additional orientation sensors may include a strategically positioned ball switch, contact sensor, contact switch, and/or tilt sensor. These sensors may be positioned to engage when a container 880 is in an acceptable position for a weight measurement to be acquired using one or more of the weight sensor(s) 840.

Machine executable instructions 835 may be stored on memory 835 to cause the processing unit to perform various processes. The instructions may be written in a language such as, but not limited to: C, FORTRAN, Basic, assembly language, Java, JavaScript, Python, and/or the like.

The processes may include determining an orientation value for container 880 and calculating a volume of the liquid 885 in the container 880 using the composite weight when the container orientation indicates that the container is in a measurable orientation. According to some of the embodiments, the measurable orientation may be approximately horizontal. This would be the case when the measurable position is when container 880 is placed on a horizontal surface such as a table, a chair, the floor, and/or the like. According to some of the embodiments, the measurable orientation may be approximately vertical. This may be the case when the measurable position is when container 880 is placed, for example, on its side. According to some other embodiments, the measurable orientation may be at an angle. For example, when the measurable position is when container 880 is placed in an angular positioned holder such as, for example, a bicycle cup holder and/or the like. In these situations, the volume may be calculated using the angle of the container position. In yet other embodiments, the measurable orientation may be a binary value. For example, a holder or platform, or the base of the container 880 or housing 810 may include a contact switch to indicate when the container 880 is in a measureable position. In this situation, the output of the switch may indicate a binary value indicating that the container is or is not properly positioned.

When the orientation is at an angle, the measurable orientation may include two, three or more dimensions of position information. In some cases, the orientation information could contain a fourth, fifth, or greater component. For example, the position could be based on a temporal sequence indicating that container 880 was properly seated into the measurable orientation/position. As indicated earlier, some embodiments may employ multiple orientation sensors to determine when the container 880 is in a measurable orientation.

Once the container 880 is in a measurable orientation/position, a composite weight measurement may be measured and/or recorded using weight sensor(s) 840. The composite weight may include the weight of the container 880, the weight of the liquid 885 in the container 880, and other miscellaneous items such as, but not limited to: the container cap, attachment mechanism 870 (when part of the container 880), and/or the like.

According to some embodiments, the container weight may be predetermined. This may be the case when a specific container 880 is used. In other embodiments, the container weight may be determined through an initial weight measurement. The composite weight may be determined as a combination of weight values from at least two of the at least one weight sensor 840 where each of the weight values is scaled using the measurable orientation. In other words, for example, when the weight sensor(s) 840 and the orientation of the container 880 is at an angle, each weight sensor 840 may register a different weight value. The final composite weight may be calculated using a sum of the scaled values. The liquid weight may, according to some embodiments, be determined as the difference between the composite weight and the container weight. When the composite weight includes miscellaneous items, the liquid weight may be determined as, for example, the difference between the composite weight and the sum of the quantity of the container weight plus the weight of the miscellaneous items.

The volume of liquid 885 in container 880 may be performed in various ways according to specific embodiments. For example, according to one of the various embodiments, the machine executable instructions may be configured to cause the processing unit to calculate the volume of liquid in the container 880 by: determining the liquid weight using the at least one composite weight and container weight; and calculating the volume of liquid in the container using the liquid weight. According to another of the various embodiments, the machine executable instructions may cause the processing unit to calculate the volume of liquid using a liquid density value. In yet another embodiment, the machine executable instructions may be configured to cause the processing unit to calculate the volume of liquid using the composite weight, a maximum composite weight and a minimum composite weight. For example, the volume of liquid 885 may be calculated using at least the composite weight divided by the difference of a maximum composite weight and a minimum composite weight. One skilled in the art will recognize that although these determinations are described as being performed by the processing unit, these determinations could also be performed by external devices using data communicated from the measurement device.

Data interface 825 may be employed to communicate data to at least one external device. The data may comprise raw measurement data or processed measurement data. Raw data may include transducer or sensor values before any type of calculation or additional processing. Processed data may include data that is lightly processed (e,g, minimal noise reduction, scaling, etc.) to highly processed and calculated data values. For example the data may include processed liquid usage data. Other types of data may include, but are not limited to: container orientation, composite weight, container weight, liquid weight, liquid usage over time, user profile information, a combination thereof, and/or the like. Additionally, data may include a timestamp(s) to indicate when measurements were obtained or calculated. Timestamps may be absolute time values (e.g. time of day, month, and/or year) and/or relative time values (e.g. time between measurements). In addition to timestamps, data may also include geo-tags that correlates to the location of measurements (or processed data values).

According to several of the embodiments, the data interface 825 may include one or more data interfaces. The data interface 825 may include one or more wireless or wired data interfaces. Example data interfaces include, but are not limited to: WiFi, 802.11, Bluetooth™, ZigBee™, NFC, USB, Firewire™, Ethernet, Cellular, a combination of the above, and/or the like.

The external device 890 may be a computing or storage device. Some of the various embodiments may be configured to communicate hydration data to a smart device that can run a hydration application to help user(s) manage their hydration without the burden of having to manually enter hydration data. Example external devices 890 include, for example, tablets, servers, computers, wearable devices, smart watches, mobile devices, smartphones, a combinations thereof, and/or the like.

External devices 890 may be configured to run a monitoring application. An example monitoring application may include a hydration monitoring application 892. A hydration monitoring application 892 may help a user determine and/or set a hydration goal. Hydration data may be automatically communicated to the monitoring application 892 running on the external device 890 via data interface 825. The hydration monitoring application 892 may provide feedback to the user regarding fluid intake.

According to some of the various embodiments, an attachment mechanism 870 may be employed and configured to mount container 880 to housing 810. As illustrated in FIGS. 2-5 and FIG. 11, the attachment mechanism employs magnets. Additional attachment mechanisms may include, but are not limited to: glue, Velcro, straps, latches, string, using threaded components, combinations thereof, and/or the like. According to some of the various embodiments, the housing 810 and attachment mechanism 870 may be unified. In other words, the housing 810 and attachment mechanism 870 may be part of the same piece. For example, the housing may include a snap bracket or other latching mechanism that is configured to connect to housing 810.

An example an exploded view of components of a measurement device 1100 as per an aspect of an embodiment is illustrated in FIG. 11. The measuring device 1100 may comprised an upper assembly 1160 with corresponding magnets 1170 and a lower assembly 1180. The upper assembly 1160 may be configured to attach to a container (e.g. 8). This may be achieved by conforming the shape of upper assembly 1160 to fit the container. This may create a strong static friction force and/or seal around the container when the upper assembly 1160 is fit on the container. The upper assembly 1160 may have a hole such that the air between the container and the upper assembly is allowed to pass through the hole when the upper assembly 1160 is fitted to the container. According to some embodiments, the hole may be sealed once the upper assembly 1160 is fitted to the container.

The lower assembly 1180 may comprise several components. Magnets 1130 may be located in the bottom of a load bearing plate 1140 so that they correspond to magnets 1170 on the upper assembly 1160. The mechanical battery containment 1142 may be positioned at the top of the loadbearing plate 1140. The loadbearing plate 1140 may contain holes 1155 such that guides may be constructed by connecting pins, screws, and/or the like, so that loadbearing plate 1140 may be mounted to the base 1110 of the lower assembly 1180. A load cell 1114 may be fitted in the base 1110 so that the loadbearing plate 1140 lies on top of the load cell 1114. The load cell 1114 may be mounted at such a height in the base 1110 so that when no downward force is exerted on loadbearing plate 1140 there is a gap between the loadbearing plate 1140 and the base 1110. A band 1120 may be used to conceal the gap between the loadbearing plate 1140 and the base 1110. The band may be constructed of a material such as silicon or rubber to resist moisture entering the assembly 1100. Electronic components 1112 may be disposed in the base 1110 to assist in the collection and communication of data to an external device. One skilled in the art will recognize that this embodiment is illustrative only and that many configurations for a measurement device maybe constructed that adapt to various components, containers, applications, and/or the like.

An example of a configuration for a weight sensor configured to measure an applied force 1215 is shown in FIG. 12. A solid base 1260 may support the sensor. A flexible material 1240 of sufficient height may be attached to the base 1260. The flexible material, may be, according to some embodiments may comprise springs, rubber, silicon, foam, combinations thereof, and/or the like. A top plate 1230 may be attached on top of the flexible material 1240. A capacitive displacement sensor 1220 may be attached on the bottom side of the top plate 1230. A conductive surface 1250 may be attached at the top of the solid plate so that the capacitive displacement sensor 1220 would be able to detect the conductive surface 1250. A gap 1270 may exist between the capacitive displacement sensor 1220 and the conductive surface 1250. The sensor may be, for example, constructed so that the gap 1270 is approximately two millimeters when no force is applied to the top plate 1230. The gap 1270 may vary depending on the force 1210 applied on the top plate. The capacitive displacement sensor 1220 may be connected to a data acquisition device where displacement data would correlate to the magnitude of the force 1210 being applied to the top plate.

According to some of the various embodiments, contact displacement transducers might also be used instead of a capacitive displacement sensor. For example, a Hall Effect sensor such as disclosed in U.S. Pat. No. 5,339,699 may be employed in some specific embodiments. This type of sensor, using a hall effect, may not need to make direct contact. Displacement sensors that may be employed according to some of the various embodiments include contact and noncontact displacement sensors. Contact displacement sensors may be gauging and/or non-gauging displacement transducers. Non-contact displacement transducers may be employed to measure the displacement and proximity of a target without physical contact. Example non-contact displacement sensors and contact displacement sensors may be obtained from Lord MicroStrain Sensing Systems of Williston, Vt.

FIG. 13 is an illustration of an alternative example configuration of a hydration monitor as per an aspect of an embodiment of the present invention. This illustration shows an embodiment of a hydration monitor configured for use with a container 1380 containing a liquid 1385. The hydration monitor may comprise a housing 1310. The housing, according to some of the various embodiments may include a guide 1360 to assist in locating container 1380. Container 1380 may be a water bottle configured to hold a liquid such as water, tea, and/or the like.

The housing 1310 may include a weight sensor 1340 communicatively connected via an interface 1330 to a processing module 1320. The processing module may be configured to make weight measurements from the weight sensor 1340 when the container 1380 is determined to be in a measurable orientation. The determination of whether the container 1380 is in a measureable orientation may be made using the combinations of the weight sensor 1340, guide(s) 1360, and/or orientation sensor(s) 1370. In some embodiments, the weight sensor 1340 may be used to make the orientation determination. In other embodiments, orientation sensor(s) 1370 may be employed to make the orientation determination. Example orientation sensors when employed with guides 1360 may include contact switches, proximity switches, and/or the like. According to some of the various embodiments, a flexible membrane 1350 may be employed as a protective barrier between container 1380 and the housing 1310.

The processing module 1320 may include a communications capability to communicate hydration relevant data to an external device 1390. Examples of external devices include mobile devices, computers, and/or the like. The external device may be configured to operate a hydration monitoring application 1392. In is envisioned that a user may consume liquid 1385 from container 1380 throughout a period of time. Periodically the user may place the container in the hydration monitor. The hydration monitor may measure the liquid 1385 in the container 1380 and report it to the external device 1390 to notify the user of their hydration status. In other embodiments, the hydration monitor may be attached to or part of the container 1380. In those cases, the orientation sensor 1370 may be configured to detect container orientation. When the container 1380 is oriented in a position in which a valid measurement of liquid 1385 may be taken, the processing module 1320 may communicate the measurement (and/or related data) to the external device 1390 to notify the user of their hydration status.

The mass-measuring device may be implemented according to many various embodiments. For example, the measurement device may be implemented as a permanent component of a container where the initial design of the container envisions the device as part of the container or as an addition to the container, where the measurement device is attached to containers that have been made without the device but are suitable for the device to be attached to them.

Embodiments of the measurement device may be attached to a container by various methods including glue, double sided adhesive tape, heat shrinking rubber material, by creating a vacuum between the measurement device and the container, combinations of thereof, and/or the like.

The battery or source of power may vary. For example, some embodiments may employ disposable, long-life or rechargeable batteries. Some embodiments may be configured to operate using wireless power technologies. Some embodiments may be configured to use external power sources such as solar cells, AC adapters, and/or the like.

Calculation of stable mass readings may employ various timing processes. For example, some embodiments may make mass calculations as measurements are taken. Some calculations may be made as a windowed operation after multiple measurements are taken. Some embodiments may make calculations on a timed schedule.

The load cell may be employed for measuring very small or very large masses.

The measurement device may be adapted to fit the base of various container(s). For example, a measurement device may be adapted to mount to the base of a water bottle, a soda can, a cup, and/or the like. The measurement device could be adapted to be compatible with multiple containers so that a user may move the measurement device from one container to another container throughout a day to collect a measurement of all liquid consumed by the user throughout the day.

Alternative devices may be employed to determine the position of the container. So even though several of the disclosed embodiments have referred to using accelerometer(s), other devices such as an electronic gyroscope could be used to determine weight bearing position.

Other sensors such as a temperature sensor or a GPS receiver may be added to the device and readings from those sensors may be recorded either at the time of the measurement or at other times by the module.

Instead of single load cell, a set of half-bridge load cells may be employed to measure mass. In this example case, an embodiment may be configured to enable the load cells to directly interact with the base on which the container is deposited (the load cells measures the entire weight of the container and measuring device). Load cells may also be configured to allow measurements when a container is in an angular position. In this example, the mass calculation may consider the partial contribution of the measurement from the various load cells and their angular placement.

The enclosure of the measurement device may be made from a wide range of materials that offer long durability such as plastics, carbon fiber, metals (e.g. aluminum and alloys), combinations thereof, and/or the like. The enclosure may also be configured with multiple layers. For example, the measurement device enclosure may have an outer layer capable of absorbing impacts such as rubber.

The measurement device may employ other types of wireless or wired transmission to communicate collected and other data. For example some of the various embodiments may employ wireless interfaces between a measurement device and an external device such as Wi-Fi, ZigBee, Bluetooth, Bluetooth Smart, 802.11, cellular, and/or the like. For example some of the various embodiments may employ wired interfaces between a measurement device and an external device such as Ethernet, USB, RS-242, RS-232, and/or the like.

Different magnet configurations may be applied for joining lower and upper assemblies (i.e. instead of 4 pairs of magnets, only 3 or 2 pairs of magnets). Additionally, lower and upper assemblies may be joined by a mechanism that does not require a magnet such as a thread, Velcro, glue, tape, suction, a combination thereof, and/or the like.

Load cell(s) and or other measurement sensors may be powered by separate power source(s) (i.e. separate battery). For example, a BLE module may be used to signal when to send power to the measurement sensor even though it may not power the measurement sensor directly.

Output signal(s) from sensors (such as a load cell or accelerometer), may be amplified to be compatible with the input conversion capability of the processing module. For example, the sensor output may be an analog signal that is converted into a digital value using an analog-to-digital converter. In the case that the resolution of the analog-to-digital converter is too low, an amplifier may be employed to increase the resolution of the signal. Alternatively, if the analog output is too large, an attenuation circuit may be employed to reduce the signal size. Some embodiments may employ automatic gain amplifier circuits.

This measuring device may be configured with a custom container. The custom container may have an area (e.g. hollow bottom) to encompass the measurement device and/or sensor(s). In that way, the measuring device may be configured to transfer the mass of the content of the container without the mass of the container.

The load bearing plate and the upper assembly may be made as a single component. This may eliminate the need for magnets or other methods of connecting the load bearing plate and the upper assembly as they form one component. The battery in such a design may be located elsewhere such as in an accessible compartment in the base of the measuring device.

The upper assembly may also be attached to the container employing heat-shrinking rubber material. The rubber material may be positioned around the upper assembly and bottom of the container. The heat-shrinking rubber material may be heated, for example, by a hot air gun or a normal blow dryer. The heat may cause the rubber material to shrink and therefore bonds the container and the upper assembly together.

It may also be possible to connect the load cell to the base via glue or radially expanding rods, or by special custom made pins.

The displacement between the bearing plate and the base may be filled with soft silicone or similar material in order to achieve water resistance of the measurement device. Such material may, for example, be fitted around the gap (e.g. a silicon and/or rubber band).

According to some alternative embodiments of the mass measuring algorithm in FIG. 6, there could be more than just one threshold value responsible for activation. For example, several threshold values on separate x, y, and z axes that change over time may be employed to activate the process. A separate process may also be implemented that monitors movement of the measurement device by reading input from the accelerometer and deciding when to activate the example process illustrated in the flowchart of FIG. 6. This movement may be determined by changes in accelerometer x, y and z values over time. The changes may be determined empirically (i.e. change in x, y and z values when person is picking up a bottle and carrying it to her mouth) or analytically by computer simulations of such movement.

For the mass measurement algorithm in FIG. 6 the predetermined amount between checks for bearing position may be performed in static time frames (i.e. 4 checks every 3 seconds or once every 500 milliseconds).

For the mass measurement algorithm in FIG. 6 the date stamp may include the time since the last synchronization of the measurement device with a smartphone, tablet, personal computer or any other external device that supports the appropriate mode of transmission. Time may also be represented by a number of ticks of a clock. For example, ticks of a crystal within the processing unit.

With regard to the mass measurement process illustrated in FIG. 6 the average value of the measurement may also be compared to a last stored value of the previous measurement before it gets saved. If the values (current average value and last stored value) do not differ by more than a predetermined amount, the last stored value may get overwritten by the current average value. The current average value may be stored together with a current date stamp. If the values differ by more than a predetermined amount, the current average value may be stored alongside the last stored value and the process terminated.

For process illustrated in FIG. 7, the advertising interval may be longer than 1 second (i.e. 30 s). The advertising interval may also be shorter (i.e. 0.5 s).

The container bearing position may be a position where the entire mass of the material in the container can be measured. This position may correspond, according to some embodiments, to an upright position of the container. However there may be minor variances. For example, the container may be tilted slightly as long as it does not affect mass measurement by more than a predetermined amount.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that the figures and algorithms, which highlight the functionality and advantages of the present invention, are presented for example purposes only. The architecture of the present invention is sufficiently flexible and configurable, such that it may be utilized in ways other than that shown in the accompanying figures and algorithms. For example, the steps listed in any flowchart may be re-ordered or only optionally used in some embodiments.

It should be noted the terms “including” and “comprising” should be interpreted as meaning “including, but not limited to”.

In this specification, “a” and “an” and similar phrases are to be interpreted as “at least one” and “one or more.” References to “the,” “said,” and similar phrases should be interpreted as “the at least one”, “said at least one”, etc. References to “an” embodiment in this disclosure are not necessarily to the same embodiment.

It is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

What is claimed is:

1. A method comprising:
receiving, by a processing device, a multitude of measurements from an orientation sensor, wherein the orientation sensor is mounted to a container;
determining, from the multitude of measurements, that the container is in an angular position where a composite weight of the container and contents of the container bear down on at least one weight sensor, wherein the at least one weight sensor is mounted to the container;
taking at least three readings of the composite weight from the at least one weight sensor;
validating that each of the at least three readings of the composite weight are:
within a minimum value and a maximum value; and
are within a difference of less than a predetermined amount to each other; and
in response to the validating, storing a composite weight value based on the at least three readings of the composite weight.

2. The method according to claim 1, wherein the orientation sensor is a 3-axis accelerometer.

3. The method according to claim 2, wherein the 3-axis accelerometer is mounted to the container via a base comprising the 3-axis accelerometer.

4. The method according to claim 3, wherein the base comprises the at least one weight sensor.

5. The method according to claim 1, wherein the at least one weight sensor is mounted to the container via a base comprising the at least one weight sensor.

6. The method according to claim 1, wherein the at least one weight sensor is mounted to the container via a housing configured to hold the container, the housing comprising the at least one weight sensor.

7. The method according to claim 6, wherein:
the at least one weight sensor comprises at least two weight sensors; and
the orientation sensor comprises at least two of the at least two weight sensors.

8. The method according to claim 7, further comprising determining the angular position using differential pressure measurements of the at least two weight sensors.

9. The method according to claim 1, further comprising storing at least one timestamp of the composite weight value, wherein the at least three readings of the composite weight are taken within 0.2 seconds of each other.

10. The method according to claim 9, further comprising:
establishing a wireless connection with a mobile client; and
transmitting to the mobile client:
the composite weight value; and
the timestamp.

11. The method according to claim 10, wherein the mobile client comprises a hydration monitoring application.

12. The method according to claim 11, further comprising transmitting the angular position to the mobile client.

13. The method according to claim 12, wherein the angular position is between zero and 90 degrees.

14. The method according to claim 1, wherein the at least one weight sensor is configured as a grid of at least two weight sensors.

15. The method according to claim 1, further comprising determining a liquid weight by subtracting a weight of the container from the composite weight.

16. The method according to claim 15, further comprising calculating a volume of liquid in the container using the liquid weight.

17. The method according to claim 16, wherein the calculating the volume of liquid in the container is calculated using a liquid density value.

18. The method according to claim 16, wherein the calculating the volume of liquid in the container is calculated using: the composite weight, a maximum composite weight and a minimum composite weight.

19. The method according to claim 1, wherein the container is a handheld bottle.

20. The method according to claim 1, wherein the at least one weight sensor comprises at least one load cell.
